(19) United States
(12) Patent Application Publication
(10) Pub. No.: US 2019/0045248 A1
(43) Pub. Date: Feb. 7, 2019

(54) SUPER RESOLUTION IDENTIFIER MECHANISM

(71) Applicant: Intel Corporation, Santa Clara, CA (US)

(72) Inventors: GANG SHEN, HILLSBORO, OR (US); JILL BOYCE, PORTLAND, OR (US)

(73) Assignee: Intel Corporation, Santa Clara, CA (US)

(21) Appl. No.: 16/135,758

(22) Filed: Sep. 19, 2018

Related U.S. Application Data
(60) Provisional application No. 62/678,388, filed on May 31, 2018.

(51) Int. Cl. H04N 21/258; H04L 29/06; H04L 29/08; H04N 21/61; G06T 3/40

(52) U.S. Cl. CPC H04N 21/25825; H04L 65/608; G06T 3/4053; H04L 29/06027; H04N 21/6125; H04L 67/02

(57) ABSTRACT

An apparatus to facilitate video streaming is disclosed. The apparatus includes one or more processors to retrieve a manifest file including a first identifier to indicate a plurality of available video streams for conventional up-sampling, and a second identifier to indicate a plurality of available video streams for Super Resolution (SR), determine whether SR capability is enabled and retrieve one of the plurality video streams for SR, upon a determination that SR capability is enabled and based on the current bandwidth.

### PRIORITY

The present application is a non-provisional application based on provisional application Ser. No. 62/678,388 filed on May 31, 2018 and claims priority therefrom.

### FIELD OF INVENTION

Embodiments described herein relate generally to data processing and more particularly to facilitate Hypertext Transfer Protocol (HTTP) live streaming for devices with video super resolution capability.

### BACKGROUND OF THE DESCRIPTION

HTTP Live Streaming (HLS) provides for a client-based bit rate adaptation solution, where an HLS manifest file includes a list of available operating points, and for each operating point, the bitrate and resolution. The client selects which operating point to request, generally choosing the highest bitrate operating point which can be smoothly streamed based on estimate of the available network bandwidth from the server to the client to maximize video quality. The received video is up-sampled in the client after decoding, if necessary, using interpolation filters, such as bi-linear or bi-cubic filters.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of HTTP live streaming data flow according to one embodiment.

FIG. 2 illustrates an Rate-Distortion (RD) graph for a conventional HLS super resolution implementation.

FIG. 3 illustrates a block diagram of one embodiment of a system for implementing HLS mechanism.

FIG. 4 is a flow diagram illustrating one embodiment for performing an HLS video streaming process.

FIG. 5 illustrates one embodiment of an RD graph for an HLS super resolution implementation.

FIG. 6 illustrates a computer device capable of supporting and implementing one or more embodiments according to one embodiment.

FIG. 7 illustrates an embodiment of a computing environment capable of supporting and implementing one or more embodiments according to one embodiment.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

In embodiments, an HTTP Live Streaming (HLS) mechanism provides an HLS syntax identifier included in a manifest file that indicates an availability of one or more video streams intended (or available) for Super Resolution (SR). In further embodiments, SR enabled client devices may select and retrieve an SR video stream having the highest video quality for a given bitrate.

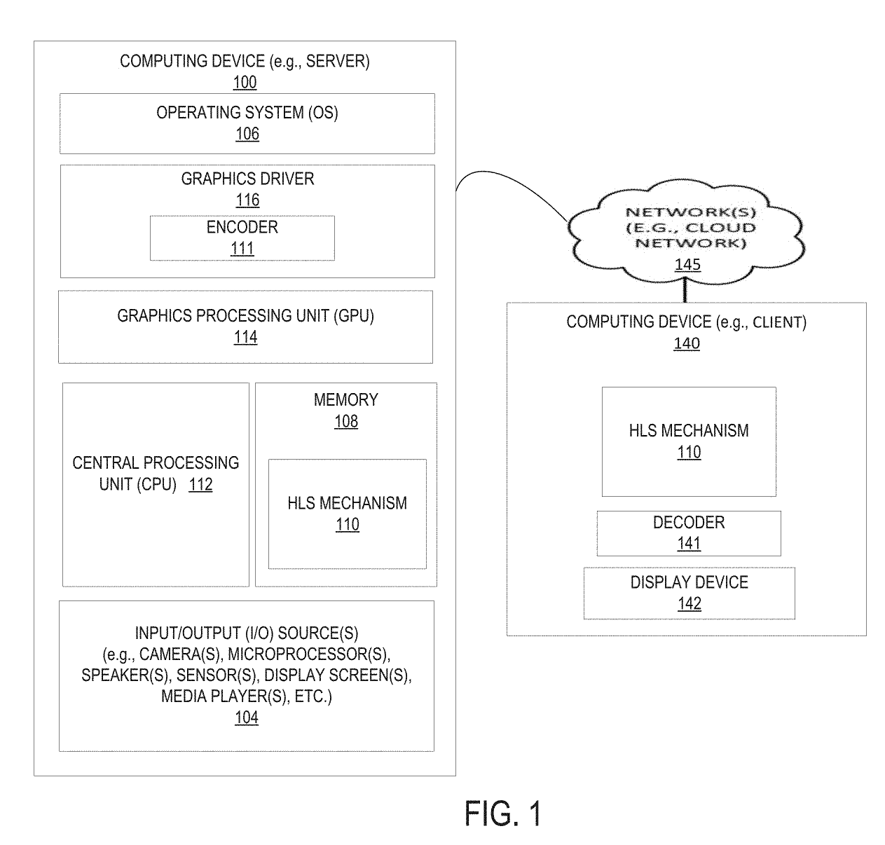

FIG. 1 illustrates a HLS super resolution (HLS) mechanism 110 according to one embodiment. For example, in one embodiment, HLS mechanism 110 of FIG. 1 may be employed or hosted by computing device 100. Computing device 100 represents a communication and data processing device including or representing any number and type of smart devices, such as (without limitation) smart command devices or intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet-based cable television set-top boxes, etc.), global positioning system (GPS)-based devices, etc.

In some embodiments, computing device 100 may include (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limited to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a cloud computing platform consisting of a plurality of server computers, where each server computer employs or hosts a multifunction perceptron mechanism. For example, automatic ISP tuning may be performed using component, system, and architectural setups described earlier in this document. For example, some of the aforementioned types of devices may be used to implement a custom learned procedure, such as using field-programmable gate arrays (FPGAs), etc.

Further, for example, computing device 100 may include a computer platform hosting an integrated circuit (“IC”), such as a system on a chip (“SoC” or “SOC”), integrating various hardware and/or software components of computing device 100 on a single chip.

As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 104, network devices, drivers, or the like, as well as input/output (I/O) sources 108, such as touchscreens, touch panels, touch pads, virtual or regular keyboards, virtual or regular mice, ports, connectors, etc. Computing device 100 may include operating system (OS) serving as an interface between hardware and/or physical resources of computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

In one embodiment, as illustrated, HLS mechanism 110 may be hosted or facilitated by memory 108 of computing device 100. In another embodiment, HLS mechanism 110 may be hosted by or be part of operating system 106 of computing device 100. In another embodiment, HLS mechanism 110 may be hosted or facilitated by graphics driver 116. In yet another embodiment, HLS mechanism 110 may be hosted by or part of graphics processing unit 114 (“GPU” or simply graphics processor”) or firmware of graphics processor 114. For example, HLS mechanism 110 may be embedded in or implemented as part of the processing hardware of graphics processor 112. Similarly, in yet another embodiment, HLS mechanism 110 may be hosted by or part of central processing unit 112 (“CPU” or simply “application processor”). For example, HLS mechanism 110 may be embedded in or implemented as part of the processing hardware of application processor 112.

In yet another embodiment, HLS mechanism 110 may be hosted by or part of any number and type of components of computing device 100, such as a portion of HLS mechanism 110 may be hosted by or part of operating system 106, another portion may be hosted by or part of graphics processor 114, another portion may be hosted by or part of application processor 112, while one or more portions of HLS mechanism 110 may be hosted by or part of operating system 106 and/or any number and type of devices of computing device 100. It is contemplated that embodiments are not limited to certain implementation or hosting of HLS mechanism 110 and that one or more portions or components of HLS mechanism 110 may be employed or implemented as hardware, software, or any combination thereof, such as firmware.

According to one embodiment, computing device 100 is coupled to one or more client computing devices (or clients) 140 via one or more networks 145. In such an embodiment, client 140 also includes HLS mechanism 110. In this embodiment, HLS mechanism 110 may be implemented at computing device 100 operating as a video server to process and encode (e.g., via encoder 111) video data for transmission to a client 140 where HLS mechanism 110 is implemented to process and decode the video data (e.g., via a decoder 141) for rendering at a display device 142.

Accordingly, server 100 and client 140 may further include network interface(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

As discussed above, HLS provides a client-based bitrate adaptation mechanism that enables client devices to manage the optimal usage of bandwidth by retrieving appropriate video segments (of different qualities) based on current network conditions. Video Super Resolution (SR) is a machine learning based technology that uses temporal and spatial information to enhance resolution of video frames. With this capability on client devices, video may be transmitted in lower resolution (therefore lower bitrate) and up-sampled to a target display resolution without significant quality loss (e.g., compared with transmitting video using the same bitrate and coded at the target resolution). At some lower bitrates, video quality is higher for video that has been coded at a lower resolution and up-sampled using super resolution at the client than video that was coded at a higher resolution using the same bitrate.

Current HLS implementations provide a client based bit rate adaptation solution. In such implementations an HLS manifest file is provided that includes a list of available operating points, as well as the bitrate and resolution for each operating point. The client selects which operating point to request, generally choosing the highest bitrate operating point that can be effectively streamed based on estimate of the available network bandwidth from the server to the client in order to maximize video quality. The received video is up-sampled in the client after decoding, if necessary, using interpolation filters, such as bi-linear or bi-cubic filters. A HLS manifest file from a Request for Comments (RFC) 8216 may include the following:
#EXTM3U
#EXT-X-STREAM-INF:BANDWIDTH=1280000,AVERAGE-BANDWIDTH=1000000
http://example.com/low.m3u8
#EXT-X-STREAM-INF:BANDWIDTH=2560000,AVERAGE-BANDWIDTH=2000000
http://example.com/mid.m3u8
#EXT-X-STREAM-INF:BANDWIDTH=7680000,AVERAGE-BANDWIDTH=6000000
http://example.com/hi.m3u8
#EXT-X-STREAM-INF:BANDWIDTH=65000,CODECS=“mp4a.40.5”
http://example.com/audio-only.m3u8.

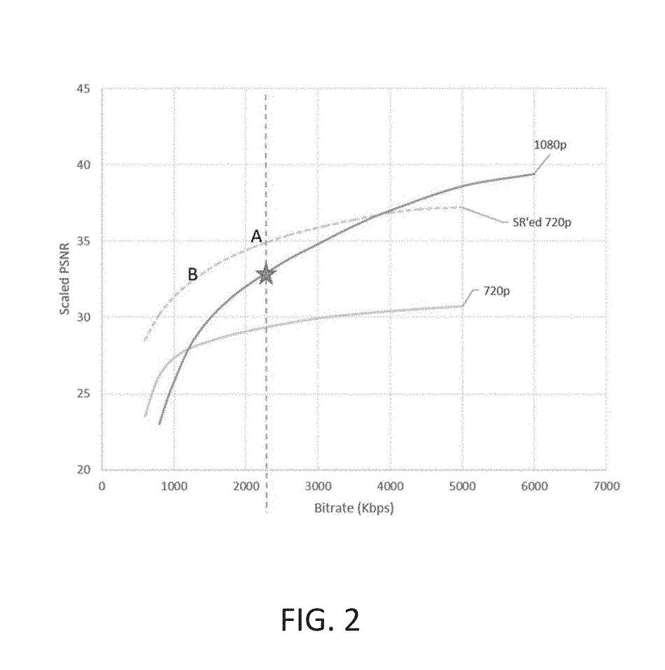

By selecting the highest bitrate/highest resolution operating point, current HLS clients may have lower video quality than if SR on video quality were taken into account. In the above-described conventional example, encoding resolutions at each operating point (“low”, “mid”, “high”) may be the same as the display resolution, resulting in the Super Resolution capability not being invoked. Moreover, by implementing the same manifest file, SR does not provide any end-to-end network bandwidth savings. For instance, FIG. 2 illustrates an RD graph (Rate-Distortion curves) for a SR implementation. As shown in FIG. 2, one operation point (marked as star) in the current HLS implementation has two issues with an SR-enabled client:
1. A video stream at this point is already 1080p, thus for a display of 1080P case there is no need for client devices to up-sample, yet the delivered quality is inferior to a video stream of 720p after super resolution (shown as point A); and
2. For the same quality of this operation point (marked as star), a different video stream of 720p can provide the same quality with super resolution on client devices with less bandwidth at point B.

According to one embodiment, HLS mechanism 110 provides a novel syntax for HLS (or similar streaming protocols such as Dynamic Adaptive Streaming over HTTP (DASH) or Smooth Streaming) that indicates video streams that present enhanced video quality along with super resolution capability in client devices. As a result, clients with super resolution capability are enabled to select a video stream having an optimum video quality for a given bitrate, and save network bandwidth without significant quality loss. In a further embodiment, the identifier is represented as “EXT-X-STREAM-SR-INF”, which is implemented in an HLS Master Playlist manifest file to indicate variant streams for client devices to apply SR.

In a further embodiment, the conventional “EXT-X-STREAM-INF” is also included in the manifest file to be used in client devices not having SR capability. Accordingly, both the “EXT-X-STREAM-SR-INF” and “EXT-X-STREAM-INF” identifiers are included in a single master player manifest file to enable client devices with or without super resolution to obtain the optimum (or best) possible video quality at various network conditions. According to one embodiment, the format for “EXT-X-STREAM-SR-INF” is provided as:
#EXT-X-STREAM-SR-INF: <attribute-list>
<URI>

In such an embodiment, attributes defined for “<attribute-list>” include: RESOLUTION (e.g., decimal values for the resolutions of the Variant Stream); BANDWIDTH (e.g., the value is a decimal-integer of bits per second, which represents the peak segment bit rate of the Variant Stream); and SCALEX (e.g., a decimal-integer value that represents a scaling factor, which is the recommended maximum scaling factor to be applied by super resolution).

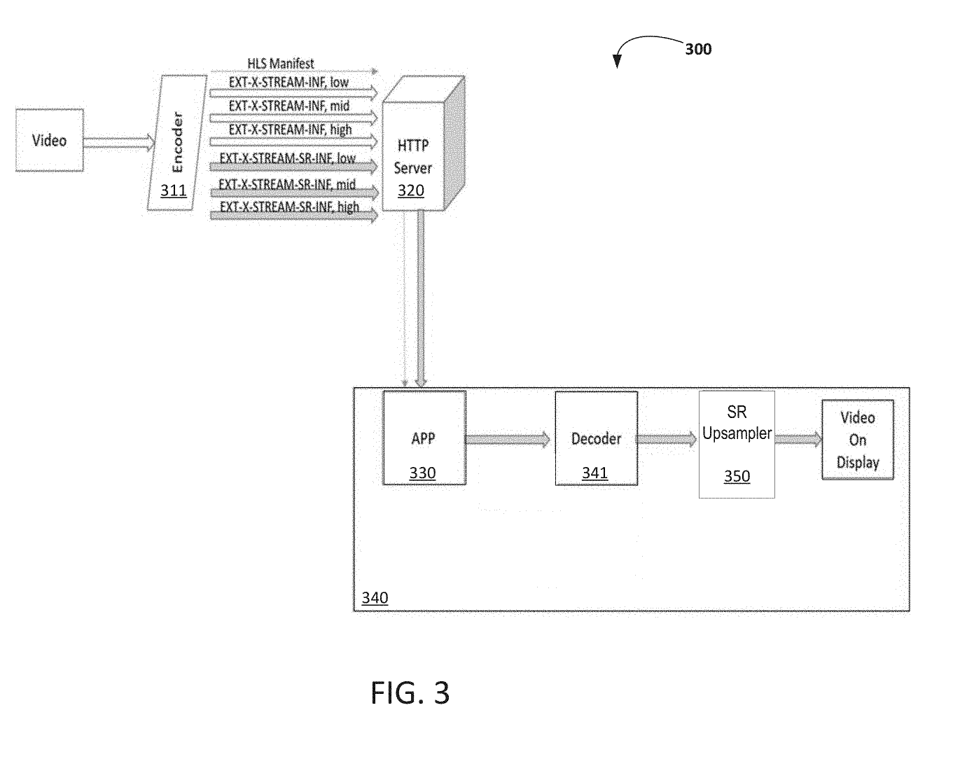

FIG. 3 illustrates a block diagram of one embodiment of a system 300 for implementing HLS mechanism 110. As shown in FIG. 3, system 300 includes an encoder 311, HTTP server 320 and an SR enabled client 340. HTTP server 320 receives the HLS manifest file from an encoder 311, which includes low, mid, and high operating points for both the “EXT-X-STREAM-SR-INF” and “EXT-X-STREAM-INF” identifiers. Thus, the new identifier enables encoder 311 and server 320 to generate an additional SR stream (e.g., lower resolution and lower bitrate) for distribution in the HLS manifest file.

Subsequently, the client device 340 retrieves the applicable stream based on operation capability. For instance, application 330 may retrieve one of the low, mid, high EXT-X-STREAM-SR-INF streams since client device 340 is SR capable. However, one of the low, mid, high EXT-X-STREAM-INF streams is retrieved for a client device that is not SR capable. In one embodiment, the stream is decoded at a decoder 341 once the applicable SR stream is retrieved. Subsequently, SR up-sampling is performed at up-sampler 350 prior to performing a bit block transfer (or bit blit) to display the video stream at a display device.

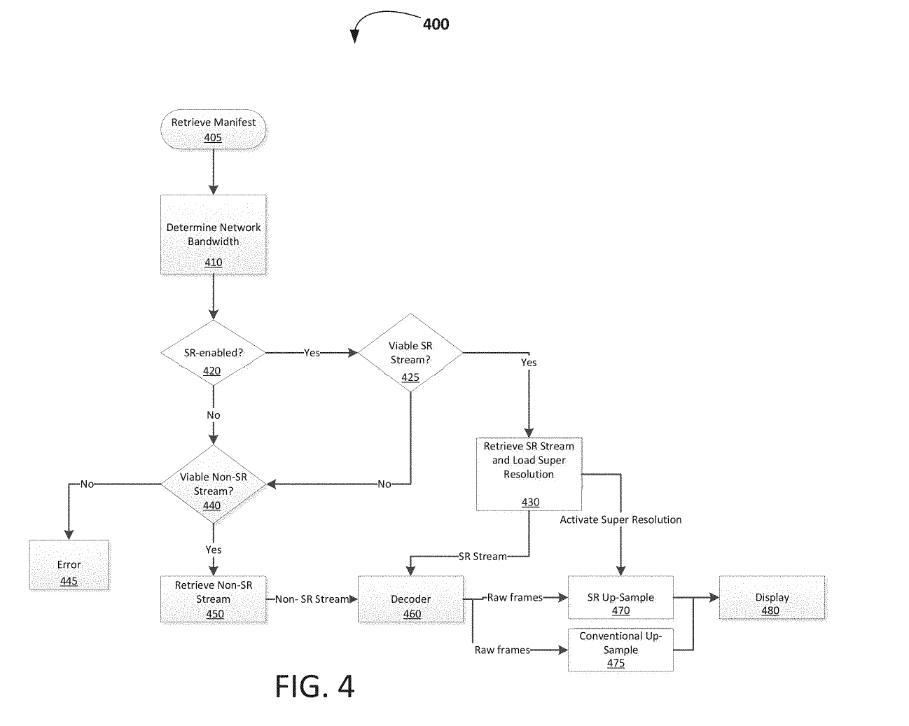

FIG. 4 is a flow diagram illustrating one embodiment of a method 400 for performing a super resolution streaming process. Method 400 may be performed by processing logic that may comprise hardware (e.g., circuitry, dedicated logic, programmable logic, etc.), software (such as instructions run on a processing device), or a combination thereof. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3 may not be repeated or discussed hereafter.

Method 400 begins at processing block 405 where a manifest is retrieved by a client (e.g. client device 140 or 340). At processing block 410, the network bandwidth is determined. At decision block 420, a determination is made as to whether the client is enabled to perform video Super Resolution (e.g., SR-enabled). If so, the client determines whether a viable SR stream (e.g., EXT-X-STREAM-SR-INF low, mid, or high) is available for retrieval, decision block 425. At processing block 430, the client retrieves the applicable SR stream, and SR is activated at the client, upon a determination that a viable SR is available stream. At processing block 460, the SR stream is decoded. At processing block 470, SR up-sampling is performed. At processing block 480, the video is displayed.

Upon a determination at decision block 420 that the client is not SR enabled, or at decision block 425 that no viable SR stream is available, a determination is made as to whether a viable non-SR stream (e.g., EXT-X-STREAM-INF low, mid, or high) is available, decision block 440. If not, no stream is available and an error message is generated, processing block 445. However, the client retrieves the applicable non-SR stream upon a determination that a viable non-SR stream is available, processing block 450. Subsequently, the non-SR stream is decoded (processing block 460), conventionally up-sampled if necessary (processing block 475), and displayed (processing block 480).

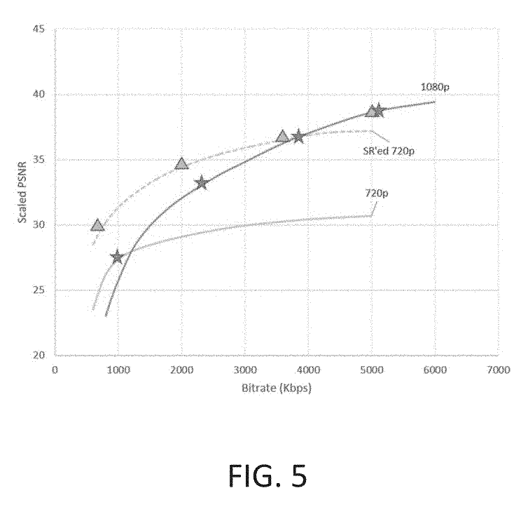

FIG. 5 illustrates one embodiment of an RD graph for a SR implementation with HLS mechanism 110. As shown FIG. 5, the stars represent a traditional master playlist of operation points denoted by EXT-X-STREAM-INF in an HLS manifest file, while the green triangles represent the new playlist of operation points denoted by EXT-X-STREAM-SR-INF for which the client will apply super resolution. In one embodiment, the operation points may be duplicated between the traditional list and the new list, as long as those are best for client devices. As shown, the new playlist provides enhanced video quality with the less bandwidth.

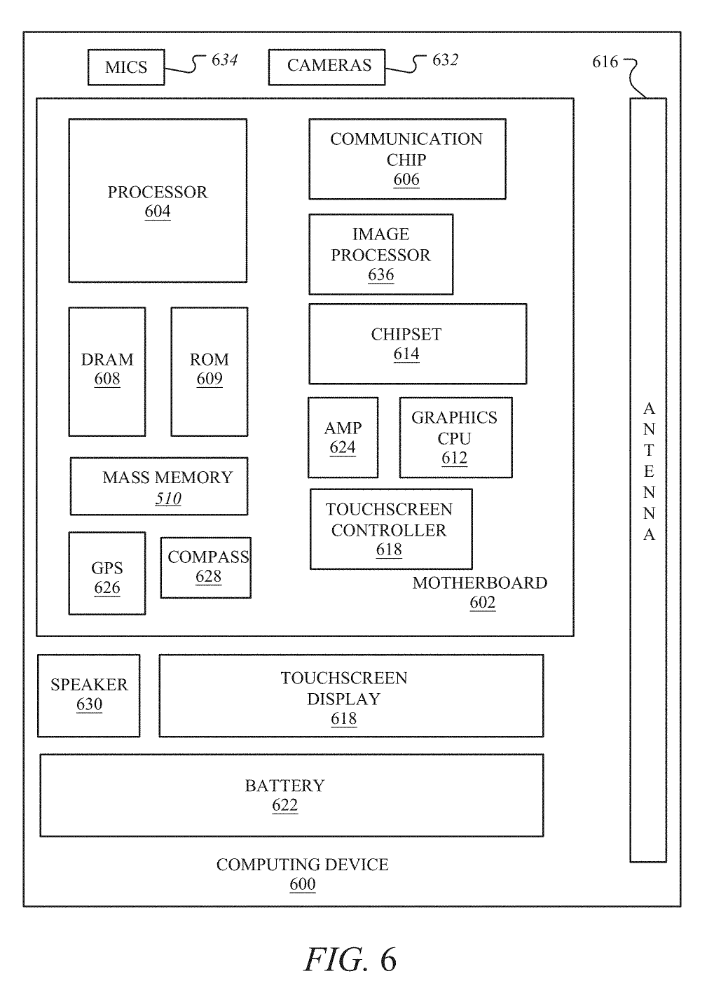

FIG. 6 illustrates a computing device 600 in accordance with one implementation. It is contemplated that computing device 600 may be the same as or similar to computing device 100 of FIG. 1 and thus for brevity, many of the details discussed with reference to computing device 100 of FIG. 1 are not discussed or repeated hereafter. Computing device 600 houses a system board 602. The board 602 may include a number of components, including but not limited to a processor 604 and at least one communication package 606. The communication package is coupled to one or more antennas 616. The processor 604 is physically and electrically coupled to the board 602.

Depending on its applications, computing device 600 may include other components that may or may not be physically and electrically coupled to the board 602. These other components include, but are not limited to, volatile memory (e.g., DRAM) 608, non-volatile memory (e.g., ROM) 609, flash memory (not shown), a graphics processor 612, a digital signal processor (not shown), a crypto processor (not shown), a chipset 614, an antenna 616, a display 618 such as a touchscreen display, a touchscreen controller 620, a battery 622, an audio codec (not shown), a video codec (not shown), a power amplifier 624, a global positioning system (GPS) device 626, a compass 628, an accelerometer (not shown), a gyroscope (not shown), a speaker 630, cameras 632, a microphone array 634, and a mass storage device (such as hard disk drive) 610, compact disk (CD) (not shown), digital versatile disk (DVD) (not shown), and so forth). These components may be connected to the system board 602, mounted to the system board, or combined with any of the other components.

The communication package 606 enables wireless and/or wired communications for the transfer of data to and from the computing device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 606 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 600 may include a plurality of communication packages 606. For instance, a first communication package 606 may be dedicated to shorter range wireless communications such as Wi-Fi and Bluetooth and a second communication package 606 may be dedicated to longer range wireless communications such as GPS, EDGE, GPRS, CDMA, WiMAX, LTE, Ev-DO, and others.

The cameras 632 including any depth sensors or proximity sensor are coupled to an optional image processor 636 to perform conversions, analysis, noise reduction, comparisons, depth or distance analysis, image understanding and other processes as described herein. The processor 604 is coupled to the image processor to drive the process with interrupts, set parameters, and control operations of image processor and the cameras. Image processing may instead be performed in the processor 604, the graphics CPU 612, the cameras 632, or in any other device.

In various implementations, the computing device 600 may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 600 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

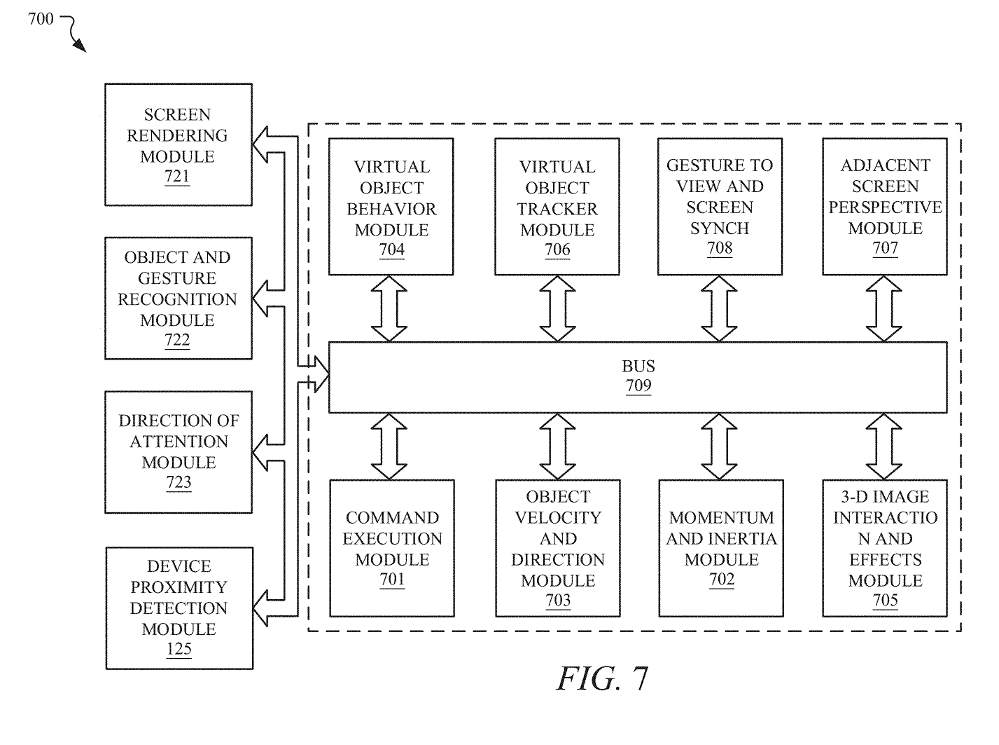

FIG. 7 illustrates an embodiment of a computing environment 700 capable of supporting the operations discussed above. The modules and systems can be implemented in a variety of different hardware architectures and form factors including that shown in FIG. 6.

The Command Execution Module 701 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 721 draws objects on the one or more multiple screens for the user to see. It can be adapted to receive the data from the Virtual Object Behavior Module 704, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 707, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition Module 722 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 723 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 722 to ensure that the gestures or commands are associated with the appropriate library for the active display. Similarly, if the user is looking away from all of the screens, then commands can be ignored.

The Device Proximity Detection Module 725 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition Module 722. For a display device, it may be considered by the Adjacent Screen Perspective Module 707.

The Virtual Object Behavior Module 704 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 706 on the other hand may be adapted to track where a virtual object should be located in three-dimensional space in a vicinity of a display, and which body part of the user is holding the virtual object, based on input from the Object and Gesture Recognition Module. The Virtual Object Tracker Module 706 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 708, receives the selection of the view and screen or both from the Direction of Attention Module 723 and, in some cases, voice commands to determine which view is the active view and which screen is the active screen. It then causes the relevant gesture library to be loaded for the Object and Gesture Recognition Module 722. Various views of an application on one or more screens can be associated with alternative gesture libraries or a set of gesture templates for a given view.

The Adjacent Screen Perspective Module 707, which may include or be coupled to the Device Proximity Detection Module 725, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 707 may, in this way, determine coordinates of an adjacent screen relative to its own screen coordinates. Thus, the Adjacent Screen Perspective Module may determine which devices are in proximity to each other, and further potential targets for moving one or more virtual objects across screens. The Adjacent Screen Perspective Module may further allow the position of the screens to be correlated to a model of three-dimensional space representing all of the existing objects and virtual objects.

The Object and Velocity and Direction Module 703 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers.

The Momentum and Inertia Module 702 can use image motion, image size, and angle changes of objects in the image plane or in a three-dimensional space to estimate the velocity and direction of objects in the space or on a display. The Momentum and Inertia Module is coupled to the Object and Gesture Recognition Module 622 to estimate the velocity of gestures performed by hands, fingers, and other body parts and then to apply those estimates to determine momentum and velocities to virtual objects that are to be affected by the gesture.

The 3D Image Interaction and Effects Module 705 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 701, 702, 703, 704, 705, 706, 707, and 708 are connected via an interconnect or a bus, such as bus 709.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes an apparatus to facilitate video streaming, comprising one or more processors to retrieve a manifest file including a first identifier to indicate a plurality of available video streams, and a second identifier to indicate a plurality of available video streams for Super Resolution (SR), determine whether SR capability is enabled and retrieve one of the plurality video streams for SR, upon a determination that SR capability is enabled and current network bandwidth condition.

Example 2 includes the subject matter of Example 1, wherein a first list of bitrate operating points is associated with the plurality of video streams indicated by the first identifier and a second list of bitrate operating points is associated with the plurality of video streams for SR indicated by the second identifier.

Example 3 includes the subject matter of Examples 1 and 2, wherein the first video stream for SR corresponds to a first bitrate in the second list of bitrate operating points.

Example 4 includes the subject matter of Examples 1-3, wherein the one or more processors further to fetch and decode the appropriate video stream for SR, according to current network condition, perform SR up-sampling on the decoded video stream and display the SR'ed video stream.

Example 5 includes the subject matter of Examples 1-4, wherein the one or more processors further to retrieve one of the plurality video streams upon a determination that SR capability is not enabled.

Example 6 includes the subject matter of Examples 1-5, wherein the video streaming is performed via a HTTP Live Streaming (HLS) protocol.

Some embodiments pertain to Example 7 that includes an apparatus to facilitate video streaming, comprising one or more processors to encode video data to generate a manifest file including a first identifier to indicate a plurality of available video streams, and a second identifier to indicate a plurality of available video streams for Super Resolution (SR).

Example 8 includes the subject matter of Example 7, wherein the one or more processors further encode the video data to generate the plurality of video streams and the plurality of video streams for SR.

Example 9 includes the subject matter of Examples 7 and 8, wherein a first list of bitrate operating points is associated with the plurality of video bitstreams indicated by the first identifier and a second list of bitrate operating points is associated with the plurality of video bitstreams for SR and indicated by the second identifier.

Some embodiments pertain to Example 10 that includes a method to facilitate video streaming, comprising retrieving a manifest file including a first identifier to indicate a plurality of available video streams, and a second identifier to indicate a plurality of available video streams for Super Resolution (SR), determining whether SR capability is enabled and retrieving one of the plurality video streams upon a determination that SR capability is enabled and current network condition.

Example 11 includes the subject matter of Example 10, wherein a first list of bitrate operating points is associated with the plurality of video streams indicated by the first identifier and a second list of bitrate operating points is associated with the plurality of video streams for Super Resolution (SR) indicated by the second identifier.

Example 12 includes the subject matter of Examples 10 and 11, wherein the retrieved SR video stream corresponds to one of a plurality of bitrates in the second list of bitrate operating points.

Example 13 includes the subject matter of Examples 10-12, further comprising decoding the retrieved SR video stream, performing SR up-sampling on the decoded SR video stream and displaying the decoded first SR video stream.

Example 14 includes the subject matter of Examples 10-13, further comprising retrieving one of the plurality video streams upon a determination that SR capability is not enabled.

Some embodiments pertain to Example 15 that includes a method to facilitate video streaming, comprising encoding video data, including generating a manifest file including a first identifier to indicate a plurality of available video streams, and a second identifier to indicate a plurality of available video streams for Super Resolution (SR) and generating the plurality of video streams and the plurality of SR video streams.

Example 16 includes the subject matter of Example 15, wherein a first list of bitrate operating points is associated with the plurality of video bitstreams indicated by the first identifier and a second list of bitrate operating points is associated with the plurality of SR video bitstreams indicated by the second identifier.

Some embodiments pertain to Example 17 that includes at least one computer readable medium having instructions stored thereon, which when executed by one or more processors, cause the processors to retrieve a manifest file including a first identifier to indicate a plurality of available video streams, and a second identifier to indicate a plurality of available video streams for Super Resolution (SR), determine whether SR capability is enabled and retrieve one of the plurality SR video streams upon a determination that SR capability is enabled.

Example 18 includes the subject matter of Example 17, wherein a first list of bitrate operating points is associated with the plurality of video streams indicated by the first identifier and a second list of bitrate operating points is associated with the plurality of video streams for SR indicated by the second identifier.

Example 19 includes the subject matter of Examples 17 and 18, wherein the first SR video stream corresponds to a first bitrate in the second list of bitrate operating points.

Example 20 includes the subject matter of Examples 17-19, decode the retrieved SR video stream, perform SR up-sampling on the decoded SR video stream and display the SR'ed video stream.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. An apparatus to facilitate video streaming, comprising:
one or more processors to retrieve a manifest file including a first identifier to indicate a plurality of available video streams, and a second identifier to indicate a plurality of available video streams for Super Resolution (SR), determine whether SR capability is enabled and retrieve one of the plurality video streams for SR, upon a determination that SR capability is enabled and current network bandwidth condition.

2. The apparatus of claim 1, wherein a first list of bitrate operating points is associated with the plurality of video streams indicated by the first identifier and a second list of bitrate operating points is associated with the plurality of video streams for SR indicated by the second identifier.

3. The apparatus of claim 2, wherein the retrieved video stream for SR corresponds to one of bitrate operating points in the second list of bitrate operating points based on current network bandwidth.

4. The apparatus of claim 3, wherein the one or more processors further to fetch and decode the appropriate video stream for SR, according to current network condition, perform SR up-sampling on the decoded video stream and display the SR video stream.

5. The apparatus of claim 1, wherein the one or more processors further to retrieve one of the plurality video streams upon a determination that SR capability is not enabled.

6. The apparatus of claim 1, wherein the video streaming is performed via a HTTP Live Streaming (HLS) protocol.

7. An apparatus to facilitate video streaming, comprising:
one or more processors to encode video data to generate a manifest file including a first identifier to indicate a plurality of available video streams, and a second identifier to indicate a plurality of available video streams for Super Resolution (SR).

8. The apparatus of claim 7, wherein the one or more processors further encode the video data to generate the plurality of video streams and the plurality of video streams for SR.

9. The apparatus of claim 8, wherein a first list of bitrate operating points is associated with the plurality of video bitstreams indicated by the first identifier and a second list of bitrate operating points is associated with the plurality of video bitstreams for SR and indicated by the second identifier.

10. A method to facilitate video streaming, comprising:
retrieving a manifest file including a first identifier to indicate a plurality of available video streams, and a second identifier to indicate a plurality of available video streams for Super Resolution (SR);
determining whether SR capability is enabled; and
retrieving one of the plurality video streams upon a determination that SR capability is enabled and current network condition.

11. The method of claim 10, wherein a first list of bitrate operating points is associated with the plurality of video streams indicated by the first identifier and a second list of bitrate operating points is associated with the plurality of video streams for Super Resolution (SR) indicated by the second identifier.

12. The method of claim 11, wherein the retrieved SR video stream corresponds to one of a plurality of bitrates in the second list of bitrate operating points.

13. The method of claim 12, further comprising:
decoding the retrieved SR video stream;
performing SR up-sampling on the decoded SR video stream; and
displaying the decoded SR video stream.

14. The method of claim 10, further comprising retrieving one of the plurality video streams upon a determination that SR capability is not enabled.

15. A method to facilitate video streaming, comprising:
encoding video data, including:
generating a manifest file including a first identifier to indicate a plurality of available video streams, and a second identifier to indicate a plurality of available video streams for Super Resolution (SR); and
generating the plurality of video streams and the plurality of video streams for SR.

16. The method of claim 15, wherein a first list of bitrate operating points is associated with the plurality of video bitstreams indicated by the first identifier and a second list of bitrate operating points is associated with the plurality of video bitstreams for SR indicated by the second identifier.

17. At least one computer readable medium having instructions stored thereon, which when executed by one or more processors, cause the processors to:
retrieve a manifest file including a first identifier to indicate a plurality of available video streams, and a second identifier to indicate a plurality of available video streams for Super Resolution (SR);
determine whether SR capability is enabled; and
retrieve one of the plurality of video streams for SR upon a determination that SR capability is enabled and current network bandwidth.

18. The computer readable medium of claim 17, wherein a first list of bitrate operating points is associated with the plurality of video streams indicated by the first identifier and a second list of bitrate operating points is associated with the plurality of video streams for SR indicated by the second identifier.

19. The computer readable medium of claim 18, wherein the retrieved video stream for SR corresponds to one of bitrate operating points in the second list of bitrate operating points based on current network bandwidth.

20. The computer readable medium of claim 19, having instructions stored thereon, which when executed by one or more processors, further cause the processors to:
decode the retrieved video stream for SR;
perform SR up-sampling on the decoded SR video stream; and
display the SR video stream.
